(19) United States
(12) Patent Application Publication
(10) Pub. No.: US 2026/0166769 A1
(43) Pub. Date: Jun. 18, 2026

(54) TOGGLE PRESS, PIVOT PIN, AND CUTTING AND CRIMPING BLADES

(71) Applicant: MEISSNER FILTRATION PRODUCTS, INC., Camarillo, CA (US)

(72) Inventor: Christopher J. Starnes, Camarillo, CA (US)

(21) Appl. No.: 19/416,240

(22) Filed: Dec. 11, 2025

Related U.S. Application Data
(60) Provisional application No. 63/733,946, filed on Dec. 13, 2024.

(51) Int. Cl. B26D 3/16; B26D 1/00; B26D 1/08; B26D 5/10; B29C 67/00; B29L 23/00

(52) U.S. Cl. CPC B26D 3/169; B26D 1/0006; B26D 1/08; B26D 5/10; B29C 67/0014; B26D 2001/0033; B26D 2001/004; B26D 2001/0053; B26D 2001/0066; B26D 2001/0086; B29L 2023/007

(57) ABSTRACT

A blade assembly includes an upper blade including a body portion; an anvil portion extending from the body portion; and a pair of crimping portions extending from the body portion on opposite sides of the anvil portion. The blade assembly also includes a lower blade including a body portion including an anvil receptacle portion; a relief area in communication with the anvil receptacle portion; and a sheering portion between the anvil receptacle portion and the relief area.

### CROSS-REFERENCE TO RELATED APPLICATION(S)

The present application claims priority to and the benefit of U.S. Provisional Application No. 63/733,946, filed Dec. 13, 2024 in the United States Patent and Trademark Office, the entire disclosure of which is incorporated herein by reference.

The present application is related to U.S. Provisional Application Nos. 63/733,959 and 63/733,963, the entire disclosure of both of which is incorporated herein by reference.

### BACKGROUND

### 1. Field

The present disclosure relates to embodiments of a toggle press, a pivot pin, and cutting and crimping blades.

### 2. Description of Related Art

A variety of different types of tools exist for cutting tubing or piping, including ratcheting pipe cutters. However, many of these tools provide insufficient mechanical advantage and therefore the process of utilizing the tool to manually cut the pipe is difficult. Additionally, many related art tools do not additionally crimp the ends of the pipe after the cutting operation, and therefore a separate crimping operation is required, which is labor intensive and time-consuming.

The above information disclosed in this section is for the enhancement of the understanding of the background of the present disclosure, and therefore it may contain information that does not constitute prior art.

### SUMMARY

The present disclosure relates to various embodiments of a toggle press. In one embodiment, the toggle press includes a body; a lower platen coupled to the body; an upper platen movably coupled to the body; a handle; and a compound lever assembly coupling the handle to the body and the upper platen. The compound lever assembly includes a primary lever rotatably coupled to the body and a secondary lever coupling the primary lever to the upper platen. The handle is coupled to the secondary lever. The handle is configured to rotate between a fully open position and a fully closed position. Rotation of the handle is configured to move the upper platen toward or away from the lower platen. The compound lever is configured to contract in response to the handle moving from the fully open position to the fully closed position and to elongate in response to the handle moving from the fully closed position to the fully open position.

The present disclosure relates to various embodiments of a blade assembly. In one embodiment, the blade assembly includes an upper blade including a body portion; an anvil portion extending from the body portion; and a pair of crimping portions extending from the body portion on opposite sides of the anvil portion. The blade assembly also includes a lower blade including a body portion including an anvil receptacle portion; a relief area in communication with the anvil receptacle portion; and a sheering portion between the anvil receptacle portion and the relief area.

The present disclosure also relates to various embodiments of a fastening system. In one embodiment, the fastening system includes a pivot pin including a head portion; an unthreaded shoulder portion extending from the head portion; and a threaded portion extending from the unthreaded shoulder portion. The head portion includes slots in which each slot includes an inner curved portion and a pair of straight segments extending outward from opposite sides of the inner curved portion.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable method, system, or device.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIGS. 1A-1G are a perspective view, a side view, a front view, a rear view, a top view, a bottom view, and another perspective view, respectively, of a toggle press according to one embodiment of the present disclosure;

FIGS. 2A-2D are a front view, a side view, a top view, and a bottom view, respectively, of a lower die according to one embodiment of the present disclosure;

FIGS. 3A-3C are a front view, a side view, and a top view, respectively, of an upper die according to one embodiment of the present disclosure;

FIGS. 4A-4B are a front view and a side view, respectively, of an upper blade and a lower blade in an open position according to one embodiment of the present disclosure;

FIG. 4C is a front view of the upper blade and the lower blade of the embodiment of FIGS. 4A-4B in a closed position;

FIG. 4D is a detail view of the upper blade and the lower blade of the embodiment of FIG. 4C;

FIGS. 5A-5C are a perspective view, a front view, and a side view, respectively, of a pivot pin according to one embodiment of the present disclosure;

FIGS. 6A-6C are a perspective view, a front view, and a side view, respectively, of a drive mechanism according to one embodiment of the present disclosure that is configured to torque the pivot pin; and

FIGS. 7A-7C are side views depicting operation of the toggle press in a fully open position, an intermediate position, and a closed position, respectively, according to one embodiment of the present disclosure.

### DETAILED DESCRIPTION

The present disclosure relates to various embodiments of a toggle press configured to cut and crimp a tube or a pipe, such as a pinch pipe fitted over a portion of elastomeric tubing (e.g., elastomeric medical tubing formed of silicone or thermoplastic elastomer (TPE) rubber). In one or more embodiments, the toggle press includes a lower jaw and an upper jaw configured to move toward and away from the lower jaw in response to the rotation of a handle. The upper jaw is configured to support an upper blade and the lower jaw is configured to support a lower blade. Together, the upper and lower blades are configured to cut and crimp a tube or a pipe. Additionally, in one or more embodiments, the toggle press includes a compound lever assembly including a primary lever and a secondary lever coupling the handle to the upper jaw. The compound lever assembly is configured to increase the displacement of the upper jaw (i.e., the distance between the upper and lower jaws) and to increase the mechanical advantage of the handle while maintaining a compact form. Furthermore, the toggle press includes pivot pins coupled to the compound lever that enable rotation of primary and secondary levers. In one or more embodiments, the pivot pins are configured to be tamper-proof (e.g., permanently installed and removable only with a custom tool) and are configured to be stronger than related art hex head fasteners and 12-point bolt head fasteners.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

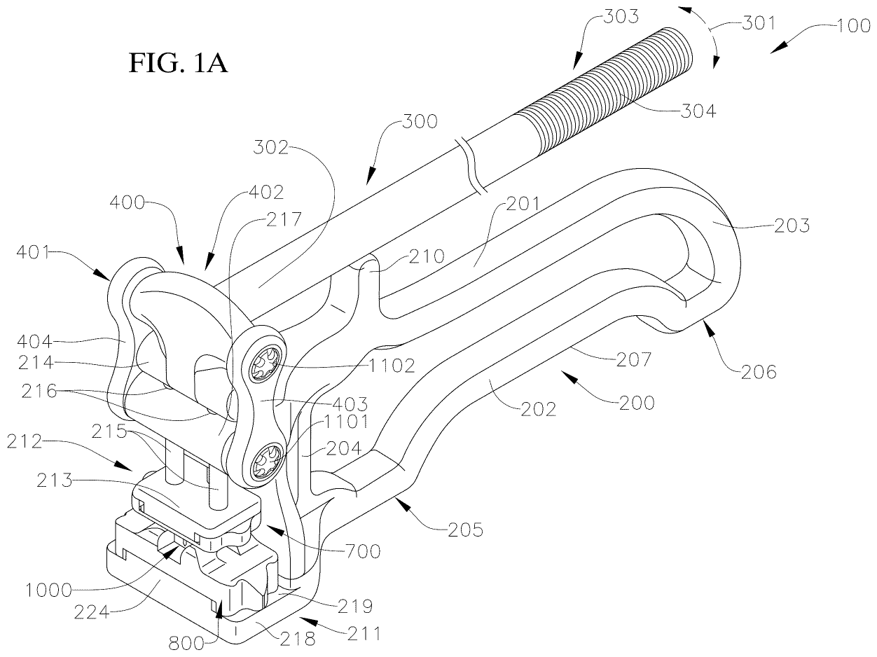

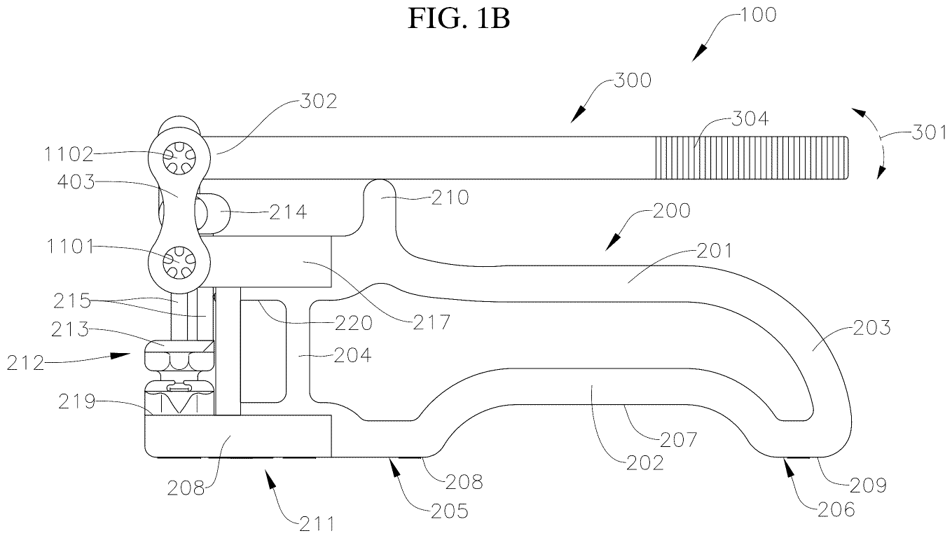

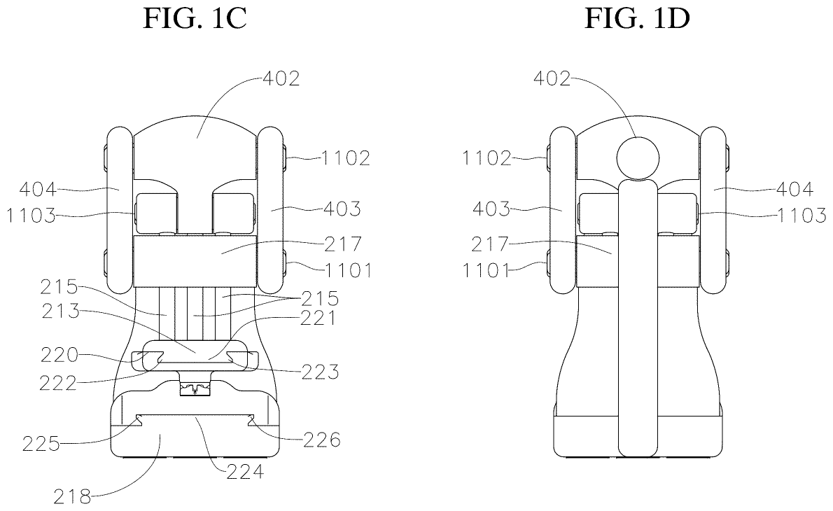

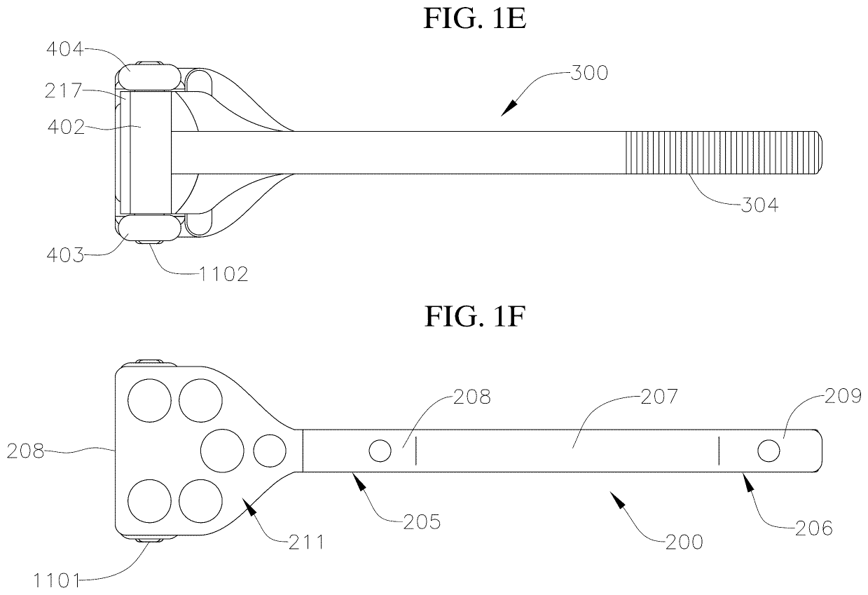

With reference now to FIGS. 1A-1G, a toggle press 100 according to one embodiment of the present disclosure includes a body 200, a handle 300 (i.e., a hand lever) rotatably coupled to the body 200, and a compound lever assembly 400 coupling the handle 300 to the body 200. In one or more embodiments, the toggle press 100 may also include a die assembly 500 configured to support a blade assembly 600 configured to cleave (i.e., cut) and crimp a pipe or tube.

In one or more embodiments, the body 200 includes an upper segment 201 (e.g., an upper rod or bar) and a lower segment 202 (e.g., a lower rod or bar) spaced apart from the upper segment 201. In one or more embodiments, the upper and lower segments 201, 202 may extend parallel or substantially parallel to each other. Additionally, in one or more embodiments, the upper and lower segments 201, 202 may be horizontal or substantially horizontal when the toggle press 100 is supported on a work surface. Rear ends of the upper and lower segments 201, 202 are connected by a rear connecting segment 203 (e.g., a curved (arcuate) segment) and front ends of the upper and lower segments 201, 202 are connected by a front connecting segment 204. Although in the illustrated embodiment the upper and lower segments 201, 202 and the rear connecting segment 203 have a square or rectangular cross-section with rounded corners, in one or more embodiments the upper and lower segments 201, 202 and the rear connecting segment 203 may have any other suitable cross-sectional shape, such as a circular cross-sectional shape. Additionally, in one or more embodiments, the body 200 may be formed of aluminum (e.g., 11075 aluminum or 6061 aluminum) and the body 200 may include an abrasion resistant coating. In one or more embodiments, the abrasion resistant coating provides a sanitary finish such that the toggle press 100 is suitable for use in cleanroom environments. Additionally, in one or more embodiments, the materials of the body 200 enable the toggle press 100 to be sanitized in an autoclave and/or with isopropyl alcohol or other chemical sanitizer.

The lower segment 202 of the body 200 includes a pair of foot pads 205, 206 extending downward (i.e., in a direction away from the upper segment 201), and a recess 207 between the pair of foot pads 205, 206 that extends upward toward the upper segment 201 of the body 200. In the illustrated embodiment, the distance between the upper segment 201 and the lower segment 202 is greater at the foot pads 205, 206 than at the recess 207 (i.e., the distance between the upper and lower segments 201, 202 narrows at the recess 207). The pair of foot pads includes a rear foot pad 206 proximate to the rear end of the body 200 (e.g., proximate to the rear connecting segment 203) and a front foot pad 205 proximate to the front end of the body 200 (e.g., proximate to the front connecting segment 204). In one or more embodiments, lower surfaces 208, 209 of the foot pads 205, 206, respectively, are flat (planar) or substantially flat (substantially planar) and the front and rear foot pads 205, 206 are co-planar or substantially co-planar. The foot pads 205, 206 are configured to enable the toggle press 100 to stand self-supported on a platform, such as a table or a workbench, and the recess 207 is configured to enable a user to grasp the toggle press 100 and, for example, lift the toggle press 100 off of the platform and use the toggle press 100 in a handheld manner. Additionally, in one or more embodiments, each of the foot pads 205, 206 may include a non-marring material such that the foot pads 205, 206 are configured not to mar the surface on which the toggle press 100 is supported. Furthermore, in the illustrated embodiment, the body 200 is laterally symmetric (i.e., symmetric from left-to-right) and therefore the toggle press 100 is configured for ambidextrous use.

Additionally, in the illustrated embodiment, the upper segment 201 of the body 200 includes a stop 210. In the illustrated embodiment, the stop 210 is a projection extending upward (i.e., in a direction away from the lower segment 202). As described in more detail below, the stop 210 is configured to contact the handle 300 when the handle 300 is in a closed position (e.g., the stop 210 is configured to prevent further rotation of the handle 300). Preventing further rotation of the handle 300 prevents the handle 300 from contacting a user's hand when the user grasps the upper segment 201 of the body 200 and rotates the handle 300 into the closed position. That is, the stop 210 is configured to prevent further rotation of the handle 300 and thereby creates a gap between the handle 300 and the upper segment 201 of the body 200 when the handle 300 is in the closed position. In one or more embodiments, the stop 210 is closer to the front end of the body 200 than the rear end of the body 200 (e.g., the stop 210 is biased toward or proximate to the front connecting segment 204 of the body 200). Although in the illustrated embodiment the stop 210 is integral with the upper segment 201 of the body 200, in one or more embodiments the stop 210 may be a separate component that is coupled to the upper segment 201 of the body 200.

In the illustrated embodiment, the toggle press 100 also includes a lower jaw 211 (i.e., a fixed jaw) and an upper jaw 212 (i.e., a movable jaw) configured to move relative to the lower jaw 211. As described in more detail below, rotation (arrow 301) of the handle 300 is configured to move the upper jaw 212 toward or away from the lower jaw 211 (i.e., rotation (arrow 301) of the handle 300 is configured to close or open the lower and upper jaws 211, 212).

In one or more embodiments, the upper jaw 212 includes an upper platen 213, a connector 214, and at least one guide 215 (e.g., a plurality of guides) connecting the upper platen 213 to the connector 214. Each of the one or more guides 215 may be a cylindrical rod. The one or more guides 215 extend upward from the upper platen 213 and through one or more openings 216 in a support portion 217 of the body 200 that extends forward (i.e., overhangs) the front connecting segment 204 of the body 200. The lower end of the one or more guides 215 are coupled to the upper platen 213 and the upper end of the one or more guides 215 are coupled to the connector 214. The upper platen 213 and the connector 214 are on opposite sides of the support portion 217 of the body 200 (i.e., the upper plate 213 is below the support portion 217 of the body 200, and the connector 214 is above the support portion 217 of the body 200). In the illustrated embodiment, the upper jaw 212 includes three guides 215 arranged in a triangular configuration (e.g., a front guide and a pair of rear guides). In one or more embodiments, the guides 215 may be arranged in any other suitable configuration, such as a linear configuration. Although in the illustrated embodiment the upper jaw 212 includes three guides 215, in one or more embodiments, the upper jaw 212 may include any other suitable number of guides 215, such as one guide, two guides, or more than three guides.

In one or more embodiments, the lower jaw 211 includes a lower platen 218 extending forward of the front connecting segment 204 of the body 200. In one or more embodiments, an upper surface 219 of the lower platen 218 faces a lower surface 220 of the support portion 217 of the body 200. The upper platen 213 is reciprocal between the support portion 217 and the lower platen 218 in response to rotation (arrow 301) of the handle 300.

In the illustrated embodiment, the lower surface 220 of the upper platen 213 includes a dovetail-shaped projection 221 extending downward. The dovetail-shaped projection 221 of the upper platen 213 includes a pair of beveled rails 222, 223 on opposite sides of the upper platen 213. Additionally, in one or more embodiments, the lower surface 220 of the upper platen 213 may include one or more detents 228. Similarly, in the illustrated embodiment, the upper surface 219 the lower platen 218 includes a dovetail-shaped projection 224 extending upward. The dovetail-shaped projection 224 of the lower platen 218 includes a pair of beveled rails 225, 226 on opposite sides of the lower platen 218. Additionally, in one or more embodiments, the upper surface 219 of the lower platen 218 may include one or more detents 227 (see FIG. 1G).

As described in more detail below, the upper platen 213 is configured to support an upper die 700 of the die assembly 500 and the lower platen 218 is configured to support a lower die 800 of the die assembly 500. In one or more embodiments, the upper die 700 may be readily attached and detached from the upper platen 213 without the use of tools (i.e., by hand), and the lower die 800 may be readily attached and detached from the lower platen 218 without the use of tools (i.e., by hand). The upper die 700 of the die assembly 500 is configured to support an upper blade 900 of the blade assembly 600, and the lower die 80 of the die assembly 500 is configured to support a lower blade 1000 of the blade assembly 600. Together, the upper blade 900 and the lower blade 1000 are configured to cut and crimp a pipe or tube, as described in more detail below. In one or more embodiments, the upper and lower dies 700, 800 may be configured to support any other suitable type of tool, such as a crimping tool only or a pipe cutting tool only.

With continued reference to the embodiment illustrated in FIGS. 1A-1G, the compound lever assembly 400 includes a primary lever 401 and a secondary lever 402. The primary lever 401 has a first end rotatably coupled to the support portion 217 of the body 200 with a first pivot pin 1101 and a second end rotatably coupled to the secondary lever 402 with a second pivot pin 1102. The primary lever 401 includes a pair of links or linkages 403, 404 on opposite sides of the body 200. The secondary lever 402 includes a first end rotatably coupled to the second end of the primary lever 401 with the second pivot pin 1102 and a second end rotatably coupled to the upper jaw 212 with a third pivot pin 1103. The first end of the secondary lever 402 is between the pair of linkages 403, 404 of the primary lever 401.

A proximal end 302 of the handle 300 is coupled to the secondary lever 402. In the illustrated embodiment, the proximal end 302 of the handle 300 is coupled to the secondary lever 402 proximate to the second pivot pin 1102 connecting the primary lever 401 to the secondary lever 402 (e.g., the proximal end 302 of the handle 300 is between the pair of linkages 403, 404 of the primary lever 401). The handle 300 may be coupled to the secondary lever 402 in any suitable manner, such as by fastening, bonding, and/or welding. A distal end 303 of the handle 300 includes a grip 304 having one or more friction-inducing features, such as grooves, channels, and/or ribs, configured to aid the user in grasping the handle 300 without the user's hand inadvertently slipping off.

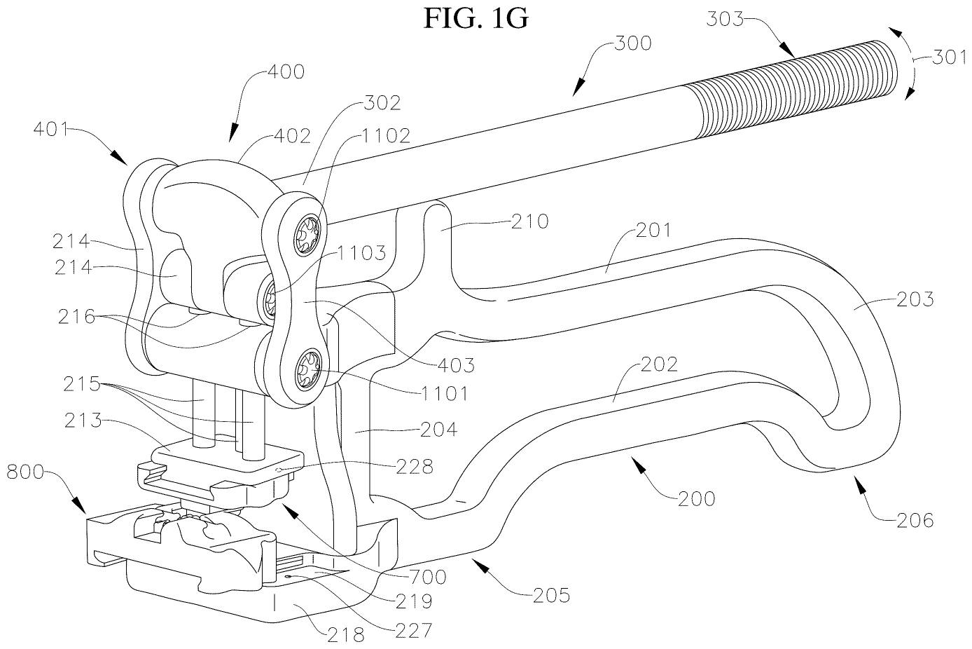

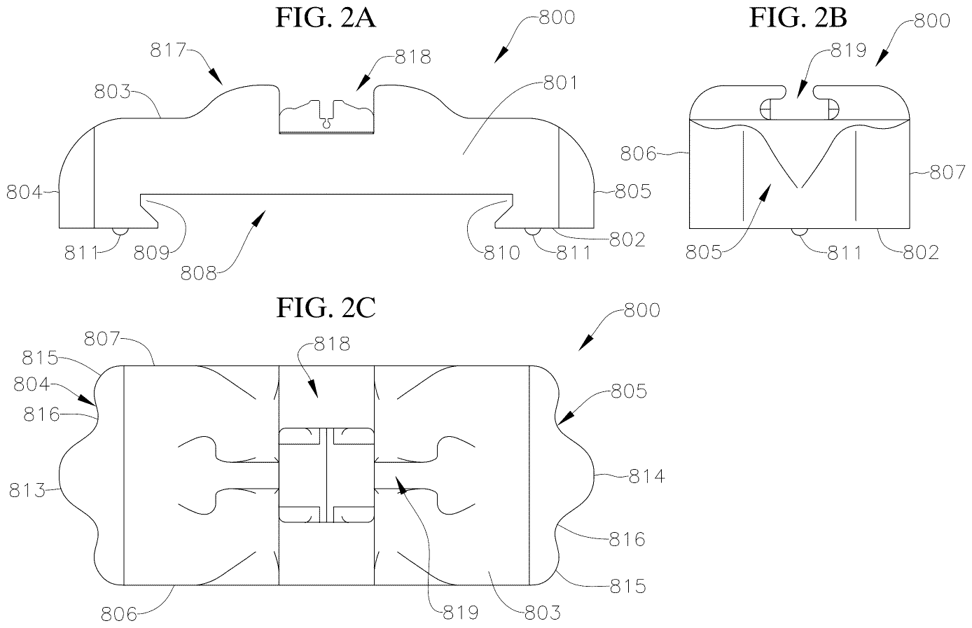

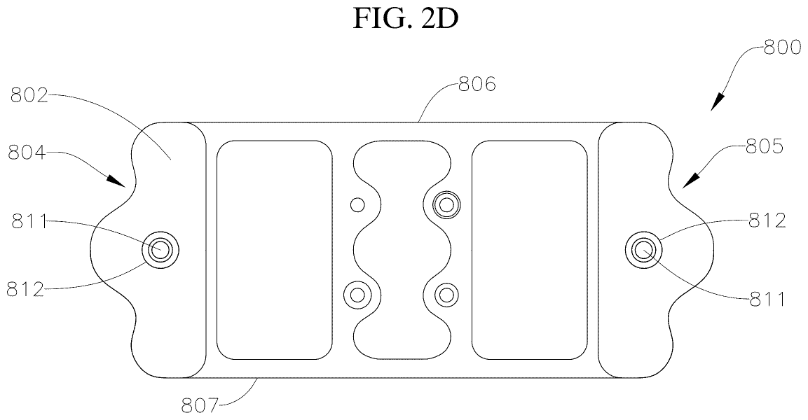

With reference now to the embodiment illustrated in FIGS. 2A-2D, the lower die 800 includes a base portion 801 having a lower wall 802 (i.e., a bottom wall), an upper wall 803, a pair of opposing sidewalls 804, 805, and a pair of opposing front and rear walls 806, 807. In the illustrated embodiment, the lower die 800 also includes a dovetail-shaped recess 808 in the lower wall 802. The dovetail-shaped recess 808 forms a pair of beveled channels 809, 810 spaced apart from each other and extending from lengthwise along the lower die 800 from the front wall 806 to the rear wall 807. To attach the lower die 800 to the lower platen 218, the dovetail-shaped recess 808 in the lower die 800 may be aligned with the dovetail-shaped projection 221 of the lower platen 218 and then the lower die 800 may be slid rearward relative to the lower platen 218. As the lower die 800 is slid rearward relative to the lower platen 218, the beveled rails 225, 226 of the lower platen 218 slide along the beveled channels 809, 810 of the lower die 800 until the dovetail-shaped projection 221 of the lower platen 218 is completely or substantially completely accommodated in the dovetail-shaped recess 808 in the lower die 800. Together, the beveled rails 225, 226 and the beveled channels 809, 810 form a lap joint between the lower platen 218 and the lower die 800. Although in the illustrated embodiment the lower die 800 includes a dovetail-shaped recess 808 configured to accommodate the dovetail-shaped projection 221 of the lower platen 218, in one or more embodiments, the lower die 800 may include a dovetail-shaped projection and the lower platen 218 may include a dovetail-shaped recess. In one or more embodiments, the lower platen 218 and the lower die 800 may be coupled to each other in any other suitable manner or manners.

Additionally, in one or more embodiments, the lower die 800 includes one or more spring-pins 811 accommodated in one or more openings 812 in the lower wall 802. In the illustrated embodiment, the lower die 800 includes a pair of spring pins 811 on opposite sides of the dovetail-shaped recess 808. Each of the spring pins 811 are configured to move between an extended position extending below the lower wall 802 and a retracted position flush or recessed relative to the lower wall 802. Each of the spring pins 811 includes a pin and a spring configured to bias the pin into the extended position. The one or more spring pins 811 of the lower die 800 and the one or more detents 227 of the lower platen 218 are configured to ensure proper alignment between the lower die 800 and the lower platen 218. When the lower die 800 is properly aligned with the lower platen 218, the one or more spring pins 811 “snap” into the one or more corresponding detents 227. In this manner, the spring pins 811 and the detents 227 are configured to self-locate the lower die 800 on the lower platen 218. The engagement between the one or more spring pins 811 and the one or more detents 227 also provides a bias force that must be overcome to remove the lower die 800 from the lower platen 218.

In the illustrated embodiment, the lower die 800 also includes one or more ridges or nubs 813, 814 extending outward from each of the sidewalls 804, 805, respectively. In one or more embodiments, the nubs 813, 814 may taper (narrow) in a direction extending away from the sidewalls 804, 805. In the illustrated embodiments, the nubs 813, 814 are centered or substantially centered along the sidewalls 804, 805 (e.g., the nubs 813, 814 are centered or substantially centered between the front wall 806 and the rear wall 807). In the illustrated embodiment, the lower die 800 also includes rounded corners 815 between the sidewalls 804, 805 and the front and rear walls 806, 807, and curved (e.g., radiused) transitions 816 between the rounded corners 815 and the nubs 813, 814. Together, the rounded corners 815, the nubs 813, 814, and the curved transitions 816 define a scalloped profile on each side of the lower die 800 that are configured to aid a user in grasping the lower die 800 to attach and detach the lower die 800 from the lower platen 218.

In the illustrated embodiment, the lower die 800 also includes a crest 817 extending upward from the upper wall 803. In one or more embodiments, the crest 817 may be centered or substantially centered between the sidewalls 804, 805. Additionally, in one or more embodiments, the crest 817 extends from the front wall 806 to the rear wall 807. Additionally, in the illustrated embodiment, the lower die 800 includes a lower blade receptacle 818 in the crest 817 that is configured to accommodate the lower blade 602. In one or more embodiments, the lower blade receptacle 818 has a rectangular cross-sectional shape and the lower blade receptacle 818 extends from the front wall 806 to the rear wall 807. Accordingly, opposite ends of the lower blade receptacle 818 are open such that the lower blade 1000 may be slid into the lower blade receptacle 818 from the front or the rear.

Furthermore, in the illustrated embodiment, the lower die 800 includes a retaining slot 819 in the crest 817 that is configured to accommodate a portion of the tube or pipe P to be cut and crimped by the toggle press 100. In the illustrated embodiment, the retaining slot 819 extends in a direction from one of the sidewalls 804 to the other sidewall 805 (e.g., the retaining slot 819 is perpendicular or substantially perpendicular to the lower blade receptacle 818). Additionally, in the illustrated embodiment, an upper portion of the retaining slot 819 is narrower than a lower portion of the retaining slot 819 (i.e., the lower portion of the retaining slot 819 is wider than the upper portion of the retaining slot 819). In the illustrated embodiment, upper portions of the crest 817 extend toward each other to define the narrower upper portion of the retaining slot 819 and the upper portions of the crest 817 extending toward each other overhang the wider lower portion of the retaining slot 819. The configuration of the retaining slot 819 is configured to retain the tube or pipe P in the retaining slot 819 during a cutting and crimping operation.

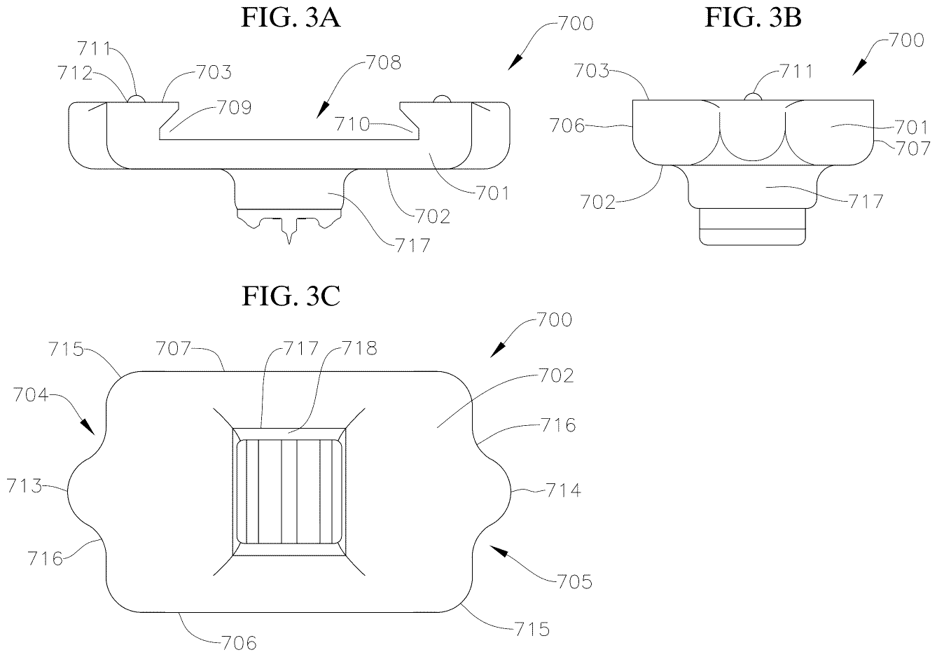

With reference now to the embodiment illustrated in FIGS. 3A-3C, the upper die 700 includes a base portion 701 having a lower wall 702 (i.e., a bottom wall), an upper wall 703, a pair of opposing sidewalls 704, 705, and a pair of opposing front and rear walls 706, 707. In the illustrated embodiment, the upper die 700 also includes a dovetail-shaped recess 708 in the upper wall 703. The dovetail-shaped recess 708 forms a pair of beveled channels 709, 710 spaced apart from each other and extending from lengthwise along the upper die 700 from the front wall 706 to the rear wall 707. To attach the upper die 700 to the upper platen 213, the dovetail-shaped recess 708 in the upper die 700 may be aligned with the dovetail-shaped projection 221 of the upper platen 213 and then the upper die 700 may be slid rearward relative to the upper platen 213. As the upper die 700 is slid rearward relative to the upper platen 213, the beveled rails 222, 223 of the upper platen 213 slide along the beveled channels 709, 710 of the upper die 700 until the dovetail-shaped projection 221 of the upper platen 213 is completely or substantially completely accommodated in the dovetail-shaped recess 708 in the upper die 700. Together, the beveled rails 222, 223 and the beveled channels 709, 710 form a lap joint between the upper platen 213 and the upper die 700. Although in the illustrated embodiment the upper die 700 includes a dovetail-shaped recess 708 configured to accommodate the dovetail-shaped projection 221 of the upper platen 213, in one or more embodiments, the upper die 700 may include a dovetail-shaped projection and the upper platen 213 may include a dovetail-shaped recess. In one or more embodiments, the upper platen 213 and the upper die 700 may be coupled to each other in any other suitable manner or manners.

Additionally, in one or more embodiments, the upper die 700 includes one or more spring-pins 711 accommodated in one or more openings 712 in the upper wall 703. In the illustrated embodiment, the upper die 700 includes a pair of spring pins 711 on opposite sides of the dovetail-shaped recess 708. Each of the spring pins 711 are configured to move between an extended position extending above the upper wall 703 and a retracted position flush or recessed relative to the upper wall 703. Each of the spring pins 711 includes a pin and a spring configured to bias the pin into the extended position. The one or more spring pins 711 of the upper die 700 and the one or more detents 228 of the upper platen 213 are configured to ensure proper alignment between the upper die 700 and the upper platen 213. When the upper die 700 is properly aligned with the upper platen 213, the one or more spring pins 711 “snap” into the one or more corresponding detents 228. In this manner, the spring pins 711 and the detents 228 are configured to self-locate the upper die 700 on the upper platen 213. The engagement between the one or more spring pins 711 and the one or more detents 228 also provides a bias force that must be overcome to remove the upper die 700 from the upper platen 213.

In the illustrated embodiment, the upper die 700 also includes one or more ridges or nubs 713, 714 extending outward from each of the sidewalls 704, 705, respectively. In one or more embodiments, the nubs 713, 714 may taper (narrow) in a direction extending away from the sidewalls 704, 705. In the illustrated embodiments, the nubs 713, 714 are centered or substantially centered along the sidewalls 704, 705 (e.g., the nubs 713, 714 are centered or substantially centered between the front wall 706 and the rear wall 707). In the illustrated embodiment, the upper die 700 also includes rounded corners 715 between the sidewalls 704, 705 and the front and rear walls 706, 707, and curved (e.g., radiused) transitions 716 between the rounded corners 715 and the nubs 713, 714. Together, the rounded corners 715, the nubs 713, 714, and the curved transitions 716 define a scalloped profile on each side of the upper die 700 that are configured to aid a user in grasping the upper die 700 to attach and detach the upper die 700 from the upper platen 213.

In the illustrated embodiment, the upper die 700 also includes a projection 717 extending downward from the lower wall 702. In one or more embodiments, the projection 717 may be centered or substantially centered between the sidewalls 704, 705 and centered or substantially centered between the front and rear walls 706, 707. Additionally, in the illustrated embodiment, the upper die 700 includes an upper blade receptacle 718 in the projection 717 that is configured to accommodate the upper blade 900. In one or more embodiments, the upper blade receptacle 718 has a rectangular cross-sectional shape.

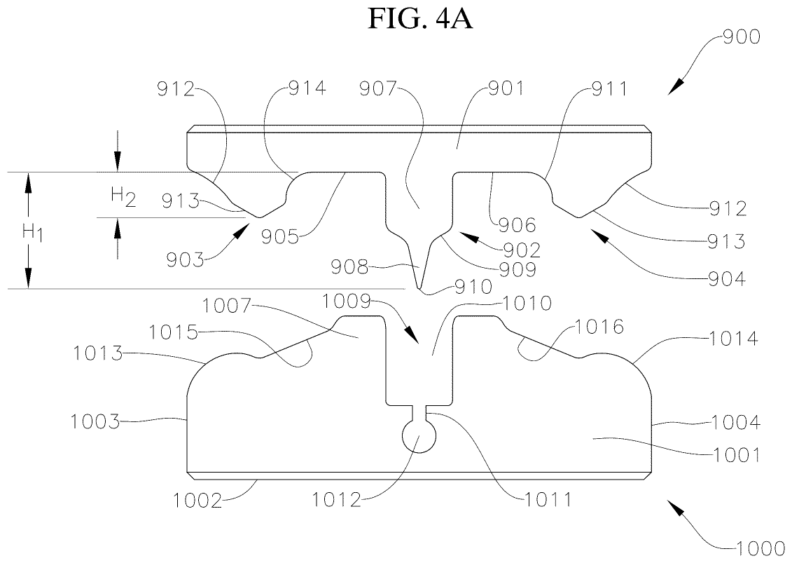

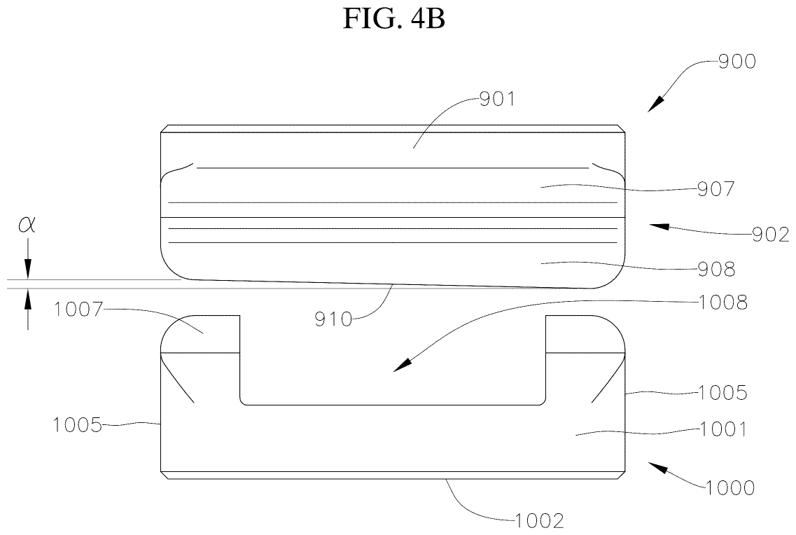

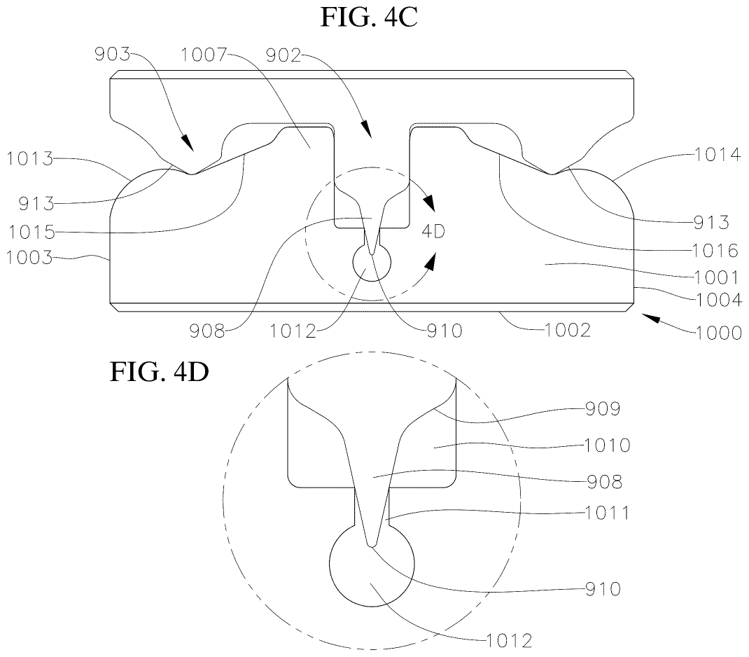

With reference now to the embodiment depicted in FIGS. 4A-4D, the upper blade 900 includes a base 901 (e.g., square plate), an anvil portion 902 projecting downward from the base 901, and a pair of crimping portions 903, 904 projecting downward from the base 901. The anvil portion 902 may be centered or substantially centered on the base 901. The crimping portions 903, 904 are on opposite sides of the anvil portion 902 (e.g., the crimping portions 903, 904 may be symmetric or substantially symmetric about the anvil portion 902). Additionally, in the illustrated embodiment, the crimping portions 903, 904 are spaced apart from the anvil portion 902 by gaps (e.g., flat or substantially flat portions 905, 906 of a lower surface of the base 901).

In the illustrated embodiment, the anvil portion 902 of the upper blade 900 includes a support portion 907 and a blade portion 908 extending downward from the support portion 907. The support portion 907 may have a constant or a substantially constant width, and the blade portion 908 may taper in a downward direction. The anvil portion 902 also includes a transition 909 between the support portion 907 and the blade 908. In the illustrated embodiment, the transition 909 is a taper. Accordingly, in the illustrated embodiment, the anvil portion 902 has a double-taper. Additionally, in the illustrated embodiment, a cutting edge 910 of the blade 908 (i.e., a lowermost end of the blade 908) is rounded (e.g., radiused), which increases safety compared to a blade with a sharp cutting edge. Furthermore, in one or more embodiments, the height of the cutting edge of the blade 908 varies along the length of the blade 908. For instance, in the illustrated embodiment, the height of the cutting edge 910 of the blade 908 tapers from a taller front end portion to a shorter rear end portion (e.g., the height of the cutting edge 910 of the blade 908 tapers at an angle α in a fore-aft direction).

In the illustrated embodiment, the crimping portions 903, 904 are symmetric or substantially symmetric about the anvil portion 902 (i.e., the crimping portions 903, 904 have the same configuration and are spaced equidistant or substantially equidistant from the anvil portion 902). Additionally, in the illustrated embodiment, each of the crimping portions 903, 904 include inner and outer radiuses 911, 912, respectively, and a taper 913 extending downward from the inner and outer radiuses 911, 912. The taper angle of the taper 913 of the crimping portions 903, 904 is less than the taper angle of the blade 908 of the anvil portion 902 (i.e., the crimping portions 903, 904 are blunter than the blade 908). Additionally, in the illustrated embodiment, the height H₂ of the crimping portions 903, 904 is less than the height H₁ of the anvil portion 902 relative to the flat portions 905, 906 of the lower surface of the base 901. In one or more embodiments, the height H₂ of the crimping portions 903, 904 may be approximately 50% or less than the height H₁ of the anvil portion 902.

In the illustrated embodiment, the lower blade 1000 includes a base 1001 having a lower (i.e., bottom) wall 1002, a pair of opposing sidewalls 1003, 1004 extending upward from opposite sides of the lower wall 1002, and a pair of opposing front and rear walls 1005, 1006 extending upward from the lower wall 1002. The front and rear walls 1005, 1006 connect opposite ends of the sidewalls 1003, 1004 together. In one or more embodiments, the base 1001 of the lower blade 1000 may be rectangular or square.

In the illustrated embodiment, the lower blade 1000 also includes a crest 1007 extending upward from an intermediate portion (e.g., a middle or substantially a middle) of the base 1001 between the sidewalls 1003, 1004. The crest 1007 extends parallel or substantially parallel to the sidewalls 1003, 1004. When the lower blade 1000 is connected to the lower die 800 and the lower die 800 is connected to the lower platen 218, the crest 1007 extends in the lengthwise direction of the body 200 of the toggle press 100.

Additionally, in the illustrated embodiment, the lower blade 1000 includes a recess 1008. The recess 1008 extends downward through the crest 1007 and widthwise (i.e., transversely) from one of the sidewalls 1003 to the other sidewall 1004 (e.g., the recess 1008 extends completely across the width of the lower blade 1000). In the illustrated embodiment, a front end of the recess 1008 is spaced apart from the front wall 1005 and a rear end of the recess 1008 is spaced apart from the rear wall 1006 such that the recess 1008 is shorter than the length of the lower blade 1000. In one or more embodiments, the recess 1008 may be centered or substantially centered between the front and rear walls 1005, 1006. Additionally, in one or more embodiments, the recess 1008 may have a square or rectangular cross-sectional shape.

The lower blade 1000 also includes an anvil receptacle 1009 extending in the fore-aft direction (i.e., the lengthwise direction). In one or more embodiments, the anvil receptacle 1009 may extend perpendicular (or substantially perpendicular) to the recess 1008. In one or more embodiments, when the lower blade 1000 is connected to the lower die 800 and the lower die 800 is connected to the lower platen 218, the anvil receptacle 1009 extends in the lengthwise direction of the body 200 of the toggle press 100. The anvil receptacle 1009 is configured to accommodate the anvil portion 902 of the upper blade 900.

In the illustrated embodiment, the anvil receptacle 1009 includes a receiving portion 1010, a sheering portion 1011 extending downward from a lower end of the receiving portion 1010, and a relief area 1012 below the sheering portion 1011. In the illustrated embodiment, an upper end of the receiving portion 1010 is open such that the anvil portion 902 of the upper blade 900 can extend down into the anvil receptacle 1009. Additionally, in one or more embodiments, the sheering portion 1011 is narrower than both the receiving portion 1010 and the relief area 1012 (e.g., the width of the anvil receptacle 1009 necks down at the sheering portion 1011). In one or more embodiments, the sheering portion 1011 may be a narrow slot or channel connecting the receiving portion 1010 to the relief area 1012. In one or more embodiments, the receiving portion 1010 may have a square or rectangular cross-sectional shape, and the relief area 1012 may be a curved (e.g., circular, oval, or elliptical) cross-sectional shape. The width of the sheering portion 1011 is equal to the width of a portion of the blade 908 of the upper blade 900. As described in more detail below, the blade 908 of the anvil portion of the upper blade 900 is configured to extend into the sheering portion 1011 of the of the lower blade 1000 to cleave the pipe or tube into two segments, and the cutting edge 910 of the upper blade 900 is configured to cause debris generated by cleaving the pipe to collect in the relief area 1012, thereby preventing (or at least mitigate against) fowling of the upper blade 900.

In the illustrated embodiment, an upper surface of the lower blade 1000 also includes a pair of shoulders 1013, 1014 on opposite sides of the anvil receptacle 1009, and an upper surface of the crest 1007 includes a pair of tapered or sloped surfaces 1015, 1016 sloping downward to the pair of shoulders 1013, 1014, respectively. A junction between the shoulders 1013, 1014 and the tapered surfaces 1015, 1016, respectively, are configured to accommodate the taper 913 of the crimping portions 903, 904, respectively. As described in more detail below, the engagement between the crimping portions 903, 904 and the junctions between the shoulders 1013, 1014 and the tapered surfaces 1015, 1016 is configured to crimp the ends of the pipe segments formed by cleaving the pipe into two segments.

Although the upper and lower blades 900, 1000 (and the upper and lower dies 700, 800) are depicted herein for use with the toggle press 100, in one or more embodiments, the upper and lower blades 900, 1000 (and the upper and lower dies 700, 800) may be used with any other suitable type of press. Additionally, although the upper and lower blades 900, 1000 are depicted herein for use with the upper and lower dies 700, 800, respectively, in one or more embodiments, the upper and lower blades 900, 1000 may be supported on the press in any other suitable manner, such as by any other suitable device or devices.

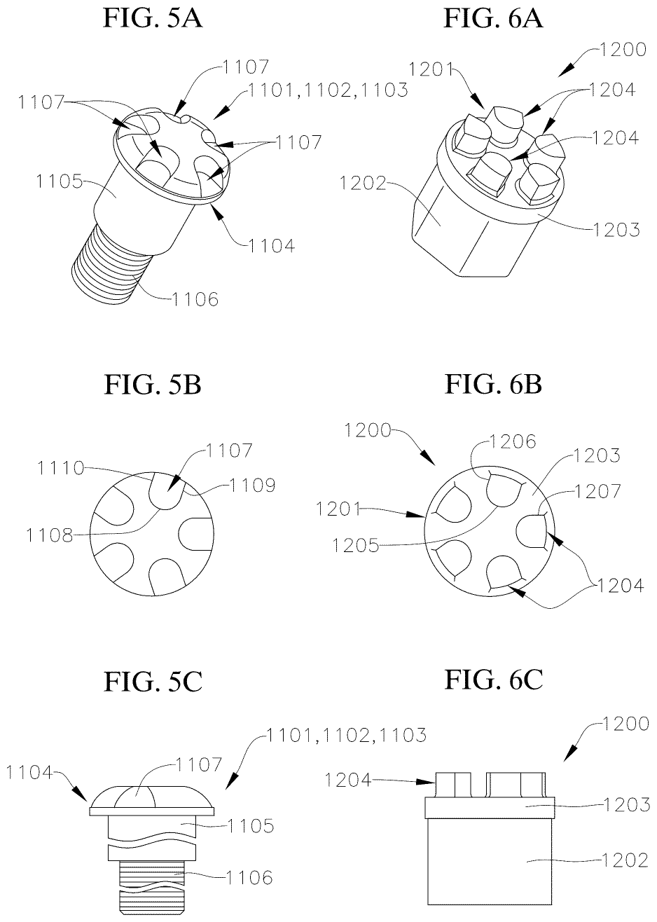

FIGS. 5A-5C depict the configuration of the first, second, and third pivot pins 1101, 1102, 1103. In one or more embodiments, the configurations of each of the first, second, and third pivot pins 1101, 1102, 1103 may be the same or substantially the same. In the illustrated embodiment, each of the pivot pins 1101, 1102, 1103 includes a head portion 1104, and unthreaded shoulder portion 1105 extending from the head portion 1104, and a threaded shaft portion 1106 extending from the unthreaded shoulder portion 1105. In one or more embodiments, each of the first, second, and third pivot pins 1101, 1102, 1103 may be a shoulder bolt. In the illustrated embodiment, the head portion 1104 is a button head including five slots 1107 circumferentially arranged around the head portion 1104. In one or more embodiments, each of the slots 1107 includes an inner curved portion 1108 (e.g., a semi-circular portion) and a pair of straight segments 1109, 1110 extending outward from opposite sides of the inner curved portion 1108. The slots 1107 may be radially oriented relative to a center point or centerline of the head portion 1104 and the slots 1107 may be equally (or substantially equally) spaced apart from each other (i.e., the slots 1107 may be arranged at regular or substantially regular intervals along the circumference of the head portion 1104). In one or more embodiments, the head portion 1104 may have a height in a range from approximately 0.14 inch to approximately 0.20 inch (e.g., approximately 0.17 inch) and the slots 1107 may have a depth in a range from approximately 0.10 inch to approximately 0.14 inch (e.g., approximately 0.12 inch). Additionally, in one or more embodiments, the head portion 1104 of each of the pivot pins 1101, 1102, 1103 may have a diameter in a range from approximately 0.6 inch to approximately 0.80 inch. In one or more embodiments, the pivot pins 1101, 1102, 1103 may be formed of grade 17-4 stainless steel (i.e., the pivot pins 1101, 1102, 1103 may contain approximately 73% iron, approximately 15-17.5% chromium, approximately 3-5% nickel, and approximately 3-5% copper, among other materials). Additionally, in one or more embodiments, the pivot pins 1101, 1102, 1103 may be electropolished and passivated, which is configured to prevent (or at least mitigate) corrosion of the pivot pins 1101, 1102, 1103. In one or more embodiments, the pivot pins 1101, 1102, 1103 may have a tensile yield of approximately 200 kpsi.

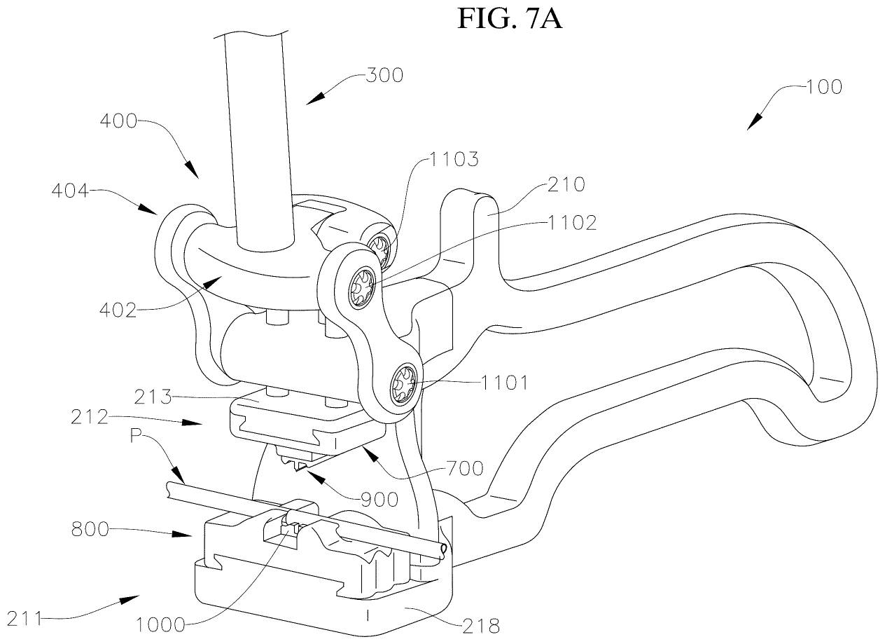

FIGS. 6A-6C depict a drive 1200 according to one embodiment of the present disclosure that is configured to install and/or remove the pivot pins 1101, 1102, 1103 from the toggle press 100. In the illustrated embodiment, the drive 1200 includes a head portion 1201 and an adapter portion 1202 extending from the head portion 1201. Additionally, the head portion 1201 of the drive includes a base 1203 (e.g., a circular flat plate) and five teeth 1204 extending upward from the base 1203. The teeth 1204 are circumferentially arranged on the base 1203. In one or more embodiments, each of the teeth 1204 includes an inner curved portion 1205 (e.g., a semi-circular portion) and a pair of straight segments 1206, 1207 extending outward from opposite sides of the curved portion 1205. The teeth 1204 may be radially oriented relative to a center point or centerline of the head portion 1201 and the teeth 1204 may be equally (or substantially equally) spaced apart from each other (i.e., the teeth 1204 may be arranged at regular or substantially regular intervals along the circumference of the head portion 1201). The shape, size, and arrangement of the teeth 1204 correspond to the shape, size, and arrangement of the slots 1107 in the pivot pins 1101, 1102, 1103. Although in the illustrated embodiment the adapter portion 1202 is a hex adapter, in one or more embodiments the adapter portion 1202 may have any other configuration suitable for the tool utilized to torque the drive 1200. The drive 1200 may include 17-4 stainless steel.

In one or more embodiments, the drive 1200 is configured to be both self-centering and positive-bottoming when engaged with the pivot pins 1101, 1102, 1103. That is, the drive 1200 is configured to “find home” and remain square (i.e., maintain proper alignment and engagement with the pivot pins 1101, 1102, 1103) better than related art Torx style drives. The configurations of the teeth 1204 of the drive 1200 and the slots 1107 in the pivot pins 1101, 1102, 1103 are configured to concentrate the torque force toward the outside diameter of the head of the head portion 1201, which enables the head portion 1201 to be smaller and lower profile than related art fastener heads (i.e., the configuration of the teeth 1204 and the corresponding slots 1107 enable high torque applications in a smaller area for a given diameter of the threaded shaft portion 1106). Additionally, the configuration of the head portion 1201 of the pivot pins 1101, 1102, 1103 is smooth on all surfaces, which is configured to prevent (or at least mitigate) against damage to other objects, such as gloves worn by a user, or to work surfaces, such as countertops.

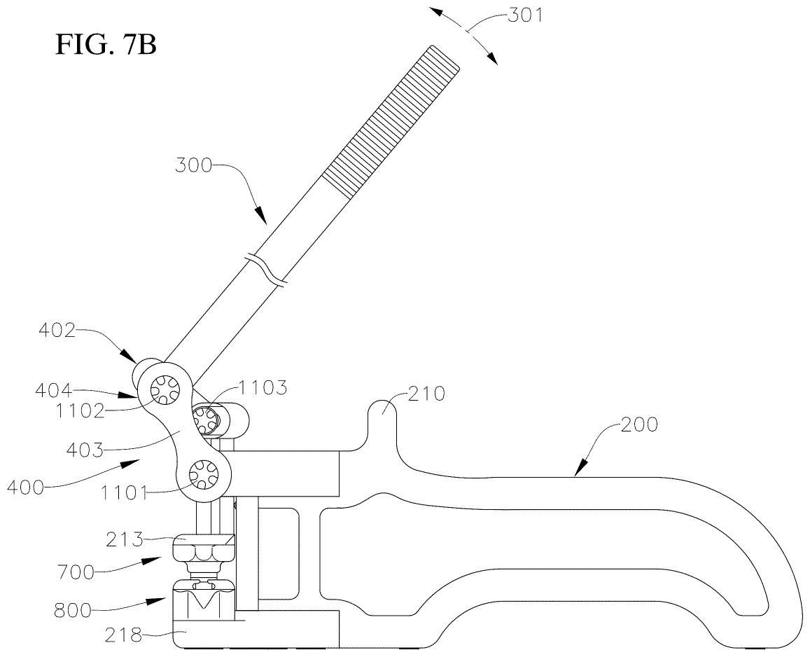

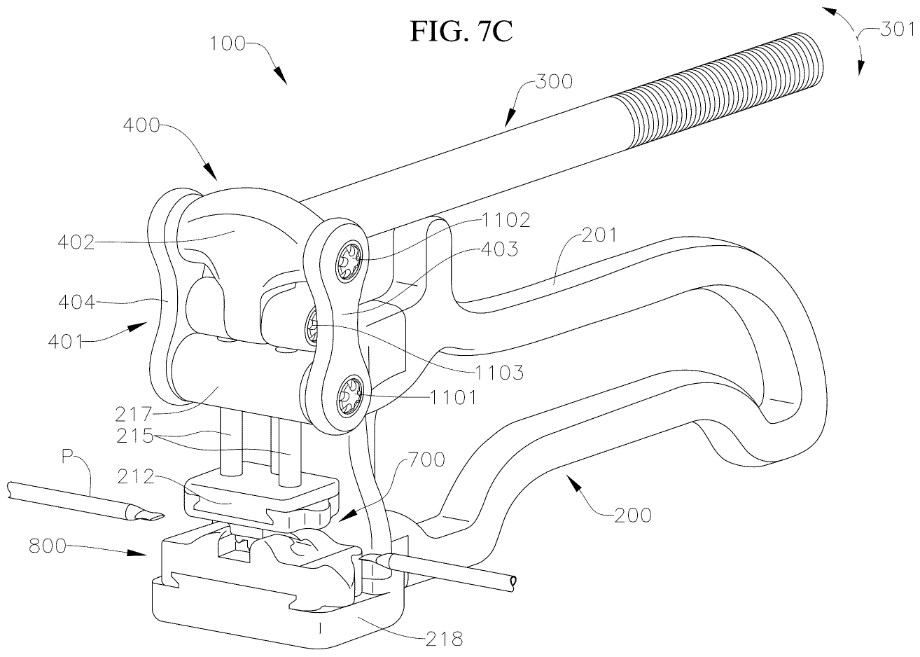

FIGS. 7A-7C depict operation of the toggle press 100 according to one embodiment of the present disclosure. When the handle 300 is in the fully open position, as depicted in FIG. 7A, the upper jaw 212 (e.g., the upper platen 213) is retracted upward and spaced apart from the lower jaw 211 (e.g., the lower platen 218). In one or more embodiments, when the handle 300 is in the fully open position, the upper platen 213 may be spaced apart from the lower platen 218 by a distance in a range from approximately 2 inches to approximately 4 inches. In the illustrated embodiment, the upper platen 213 may be spaced apart from the lower platen 218 by approximately 3 inches (e.g., 2.93 inches). Additionally, when the handle 300 is in the fully open position, the primary lever 401 and the secondary lever 402 are expanded (e.g., the primary lever 401 is not co-linear with the secondary lever 402) such that an angle is formed between the primary lever 401 and the secondary lever 402. In one or more embodiments, when the handle 300 is in the fully open position, the handle 300 may form an angle in a range from approximately 100° to approximately 106° with respect to the upper segment 201 of the body 200. In the illustrated embodiment, the angle between the handle 300 and the upper segment 201 of the body 200 is approximately 103° when the handle 300 is in the fully open position. Furthermore, in one or more embodiments, when the handle 300 is in the fully open position, the primary lever 401 of the compound lever assembly 400 may provide a mechanical advantage of approximately 12 (i.e., an approximately 12:1 force multiplier).

When the handle 300 is in the fully open position, the upper die 700 may be attached to the upper platen 213 by aligning the dovetail-shaped recess 708 in the upper die 700 with the dovetail-shaped projection 221 of the upper platen 213 and then sliding the upper die 700 rearward relative to the upper platen 213 such that the beveled rails 222, 223 of the upper platen 213 slide along the beveled channels 1109, 1110 of the upper die 700 until the dovetail-shaped projection 221 of the upper platen 213 is completely or substantially completely accommodated in the dovetail-shaped recess 708 in the upper die 700 and the one or more spring pins 811 “snap” into the one or more corresponding detents 227 in the upper platen 213. Similarly, the lower die 800 may be attached to the lower platen 218 by aligning the dovetail-shaped recess 808 in the lower die 800 with the dovetail-shaped projection 221 of the lower platen 218 and then sliding the lower die 800 rearward relative to the lower platen 218 such that the beveled rails 225, 226 of the lower platen 218 slide along the beveled channels 809, 810 of the lower die 800 until the dovetail-shaped projection 221 of the lower platen 218 is completely or substantially accommodated in the dovetail-shaped recess 808 in the lower die 800 and the one or more spring pins 811 “snap” into the one or more corresponding detents 227 in the lower platen 213. In this manner, the upper and lower dies 700, 800 may be swapped without the use of any tools. Additionally, in one or more embodiments, the upper blade may be inserted into the upper die 700 and the lower blade may be inserted into the lower die 800 before or after the upper and lower dies 700, 800 are attached to the upper and lower platens 213, 218.

Additionally, when the handle 300 is in the fully open position, a tube or pipe P (e.g., a pinch pipe fitted over a portion of elastomeric tubing) may be inserted into the pipe receptacle in the crest 817 of the lower die 800.

During operation, the body 200 of the toggle press 100 may be utilized as a handle. For instance, in one or more embodiments, the user may grasp the handle 300 with one hand and either the upper segment 201 or the lower segment 202 of the body 200 with the other hand. Grasping the lower segment 202 of the body 200 may give the user more leverage than grasping the upper segment 201 of the body 200.

As the handle 300 is rotated into an intermediate position (e.g., a middle of the stroke in which angle between the handle 300 and the upper segment 201 of the body 200 is approximately 50° and the upper and lower jaws 212, 211 are approximately 24% open), shown in FIG. 7B, the mechanical advantage begins to increase due to the eccentric movement of the compound lever assembly 400. In the intermediate position illustrated in FIG. 7B, the upper platen 213 may be spaced apart from the lower platen 218 by a distance in a range from approximately 1.5 inches to approximately 2.5 inches (e.g., approximately 2 inches).

As the handle 300 is rotated into a nearly fully closed position (e.g., in which angle between the handle 300 and the upper segment 201 of the body 200 is approximately 10° and the upper and lower jaws 212, 211 are approximately 3% open), as shown in FIG. 7C, the mechanical advantage has increased to approximately 120 (i.e., an approximately 120:1 force multiplier). In the nearly fully closed position illustrated in FIG. 7C, the upper platen 213 may be spaced apart from the lower platen 218 by a distance in a range from approximately 1.25 inches to approximately 2 inches (e.g., approximately 1.76 inches).

As the handle 300 is rotated into the closed position, the anvil portion 902 of the upper blade 900 presses down into the pipe or tube P and enters the anvil receptacle portion 1009 of the lower blade 1000. Additionally, as the handle 300 continues to rotate into the closed position, the a cutting edge 910 of the blade portion 908 of the upper blade 900 extends down into the sheering portion 1011 of the lower blade 1000, which generates a double sheering force that cuts or cleaves the pipe or tube P into two segments (e.g., opposite sides of the blade portion 908 of the upper blade 900 contact opposite sides of the sheering portion 1011 of the lower blade 1000 to generate a double sheering force that cleaves the pipe or tube P). In one or more embodiments, the split angle and the edge angle of the blade portion 908 of the upper blade 900 are configured to minimize (or at least reduce) the amount of force required to cleave the tube or pipe P into two segments. Additionally, fragments of the tube or pipe that may be generated during the cutting or cleaving of the tube or pipe P are collected in the relief area 1012 of the lower blade 1000, which prevents (or at least mitigates) fowling of the upper and lower blades 900, 1000. That is, the relief area 1012 of the lower blade 1000 may also be configured to accommodate the fragments of the pipe or tube P that are generated by the cutting of the pipe or tube P. Otherwise, the fragments generated during the cleaving of the tube or pipe P may bind to the upper blade 900 and thereby reduce the cutting efficiency of the upper blade 900 during subsequent cutting operations. Additionally, preventing the fragments that generated during the cleaving of the tube or pipe P from binding to the upper blade 900 is configured to extend the service life of the upper blade 900.

Additionally, as the handle 300 is rotated into the closed position, ends of the pipe or tube segments that were cut are compressed between the taper 913 of each of the crimping portions 903, 903 of the upper blade 900 and the junctions between the shoulders 1013, 1014 and the tapered surfaces 1015, 1016 of the lower blade 1000. In this manner, the ends of the pipe or tube segments are crimped.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A blade assembly comprising:
an upper blade comprising:
a body portion;
an anvil portion extending from the body portion;
a pair of crimping portions extending from the body portion on opposite sides of the anvil portion; and
a lower blade comprising:
a body portion comprising:
an anvil receptacle portion; and
a relief area in communication with the anvil receptacle portion.

2. The blade assembly of claim 1, wherein the body portion further comprises a sheering portion between the anvil receptacle portion and the relief area.

3. The blade assembly of claim 2, wherein the sheering portion is narrower than the anvil receptacle portion.

4. The blade assembly of claim 1, wherein each of the pair of crimping portions is shorter than the anvil portion.

5. The blade assembly of claim 1, wherein the anvil portion comprises:
a support portion having a substantially constant width; and
a blade portion extending from the support portion, the blade portion tapering in a direction away from the support portion.

6. The blade assembly of claim 5, wherein a cutting edge of the blade portion is rounded.

7. The blade assembly of claim 6, wherein a height of the cutting edge varies along a length of the upper blade.

8. The blade assembly of claim 5, further comprising a taper between the support portion and the blade portion.

9. The blade assembly of claim 5, wherein, when the upper blade mates with the lower blade, a cutting edge of the blade portion extends into the relief area of the lower blade.

10. The blade assembly of claim 1, further comprising:
an upper die configured to support the upper blade; and
a lower die configured to support the lower blade.

11. The blade assembly of claim 10, wherein the upper die comprises:
a base portion;
a projection extending from the base portion; and
an upper blade receptacle in the projection, the upper blade receptacle being configured to accommodate the upper blade.

12. The blade assembly of claim 11, further comprising one of a dovetail-shaped recess or a dovetail-shaped projection at the base portion.

13. The blade assembly of claim 12, further comprising at least spring pin on a lower surface of the base portion.

14. The blade assembly of claim 10, wherein the lower die comprises:
a base portion;
a crest extending from the base portion;
a lower blade receptacle in the crest, the lower blade receptacle being configured to accommodate the lower die; and
a retaining slot in the crest, the retaining slot being configured to accommodate a pipe or a tube.

15. The blade assembly of claim 14, further comprising one of a dovetail-shaped recess or a dovetail-shaped projection at the base portion.

16. The blade assembly of claim 15, further comprising at least spring pin on a lower surface of the base portion.

17. The blade assembly of claim 1, wherein, when the upper blade mates with the lower blade, a portion of the anvil portion extends through the anvil receptacle portion and into a sheering portion between the anvil receptacle portion and the relief area.

18. The blade assembly of claim 1, wherein the lower blade further comprises:
a crest;
a pair of shoulders; and
a pair of sloped surfaces extending from the crest to the pair of shoulders.

19. The blade assembly of claim 18, wherein each of the crimping portions comprises a taper.

20. The blade assembly of claim 19, wherein, when the upper blade mates with the lower blade, the taper of each of the crimping portions engages a junction between one of the pair of shoulders and one of the pair of sloped surfaces.
